(19) United States
(12) Patent Application Publication
(10) Pub. No.: US 2013/0014028 A1
(43) Pub. Date: Jan. 10, 2013

(54) METHOD AND SYSTEM FOR DRAWING

(75) Inventors: Tara Lemmey, San Francisco, CA (US); Nikolay Surin, San Francisco, CA (US); Stanislav Vonog, San Francisco, CA (US)

(73) Assignee: Net Power and Light, Inc., San Francisco, CA (US)

(21) Appl. No.: 13/544,824

(22) Filed: Jul. 9, 2012

Related U.S. Application Data
(60) Provisional application No. 61/506,077, filed on Jul. 9, 2011.

(51) Int. Cl. G06F 3/048

(52) U.S. Cl. 715/753

(57) ABSTRACT

The present invention contemplates a variety of methods and systems for providing a drawing layer synchronized across multiple artists and devices, wherein the drawing layer can provide a computer interface for an artist.

### CROSS-REFERENCE TO RELATED APPLICATIONS

This application claims the benefit of U.S. Provisional Application No. 61/506,077 entitled “METHOD AND SYSTEM FOR DRAWING”, filed Jul. 9, 2011, and is hereby incorporated by reference in its entirety.

### BACKGROUND OF INVENTION

1. Field of Invention

The present invention relates to a drawing interface within an ensemble experience.

2. Summary of the Invention

The present invention contemplates a variety of improved methods and systems for a synchronized drawing layer with interface aspects.

### BRIEF DESCRIPTION OF DRAWINGS

These and other objects, features and characteristics of the present invention will become more apparent to those skilled in the art from a study of the following detailed description in conjunction with the appended claims and drawings, all of which form a part of this specification. In the drawings:

FIGS. 1-4 illustrate several aspects of an instantiation of the synchronized drawing layer;

FIG. 5 is a flow chart showing acts according to one aspect;

FIG. 6 is a block diagram of a portable device according to one embodiment of the present invention; and

FIG. 7 is a block diagram of a system according to one embodiment of the present invention.

### DETAILED DESCRIPTION OF THE INVENTION

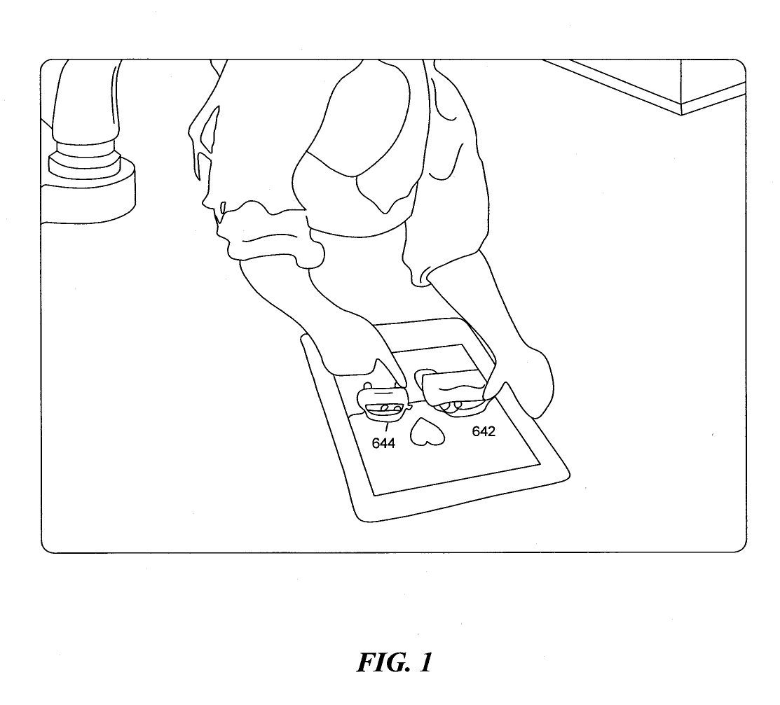

FIG. 1 illustrates an artist 10 working with device 20 to participate in an ensemble event experience. A typical ensemble event includes multiple artists, working across multiple devices, each artist often having multiple devices at their disposal. Shown in a touch screen display of device 20 are drawing layer 22 and content layer 24. In this specific example, drawing layer 22 and content layer 24 are aligned, with the drawing layer 22 appearing as an overlay above the content layer 24. The artist 10 has traced an image of a car 26 and an image of a heart 28. The system is continuously analyzing the artist's drawing in light of other input and context. The purpose is to determine what action to take in response to the artist's input. In the specific example of FIG. 1, the car image 26 corresponds to a car object in the content layer 24. The heart image 28 corresponds to a heart object in the content layer 24.

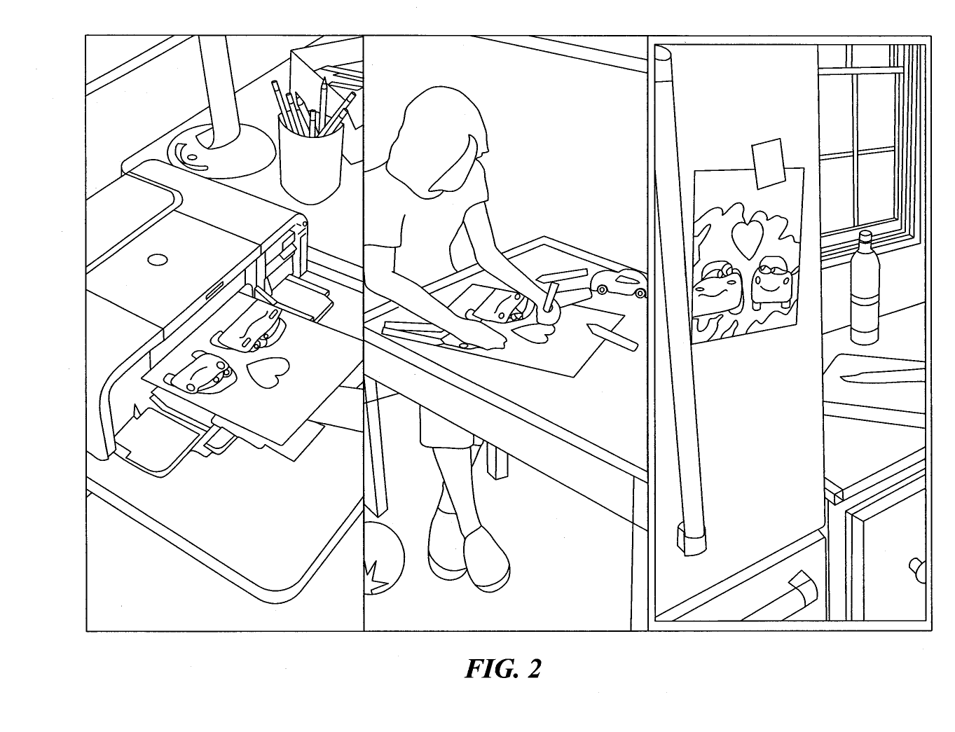

FIG. 2 illustrates using the drawing layer 22 for assistance in tracing underlying objects to create a new drawing 30 which can be stored in electronic format or printed to hard copy 32. The hard copy 32 can be decorated by the artist 10, and displayed in a desirable setting 34.

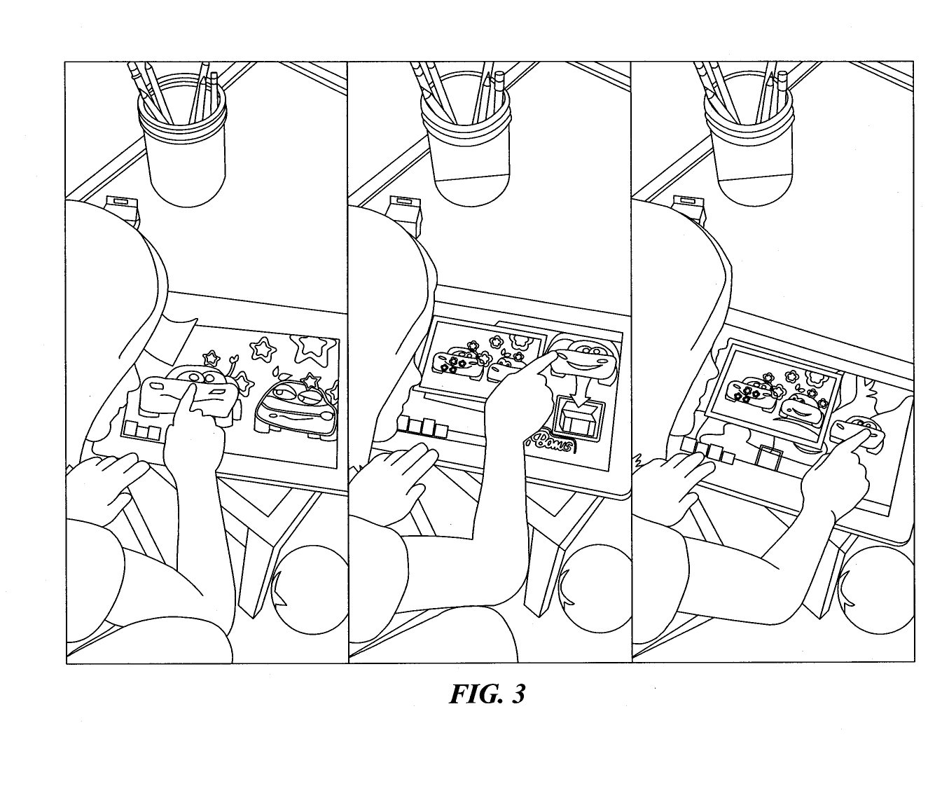

FIG. 3 illustrates using the drawing layer 22 for assistance in identifying objects associated with virtual goods and/or virtual experiences. On display instance 40, the artist 10 has traced one automobile object successfully and gets rewarded with a bonus virtual experience associated with the automobile object. On display instance 42, the artist 10 is storing the virtual experience for future use or trade. On display instance 44, the artist 10 is sharing the virtual experience with another artist.

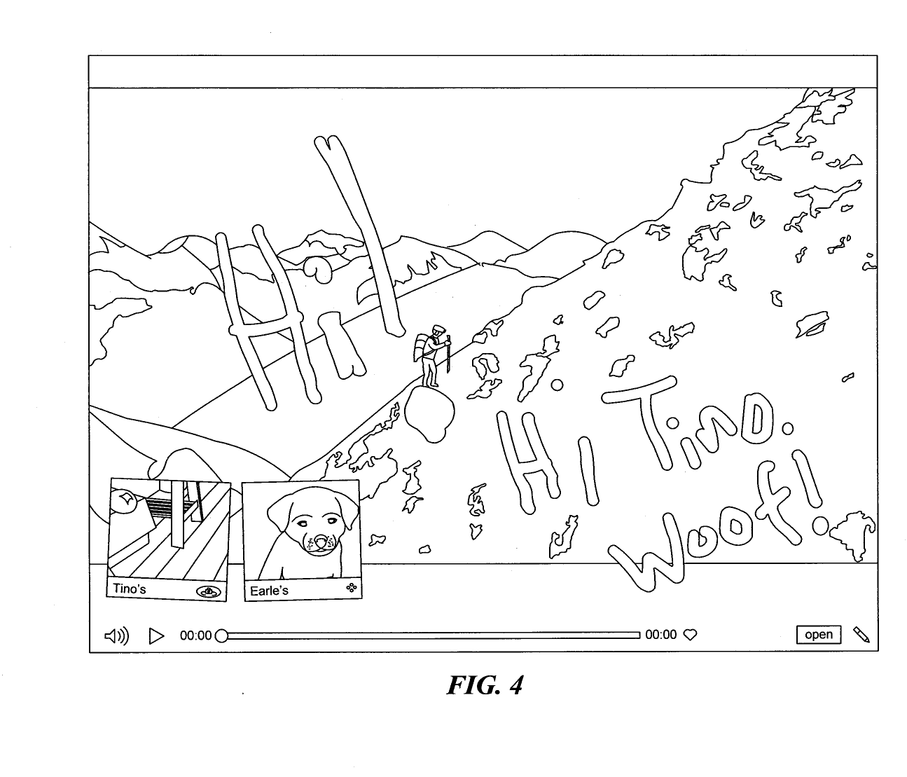

FIG. 4 illustrates one defined ensemble aspect of a drawing layer 50. In FIG. 4 two artists are working on a synchronized drawing layer, the drawing layer 50 simply being a local instance of the synchronized drawing layer. One feature indicated in FIG. 4 is the assignment of distinct colors for each artist participating; namely, drawing 52 is in blue and drawing 54 is in red. This simple example serves to illustrate how the system synchronizes around defined ensemble behavior. All layers have defined ensemble behavior. So here if a first artist is drawing in blue, another artist would draw in red, to make it clear who is drawing what.

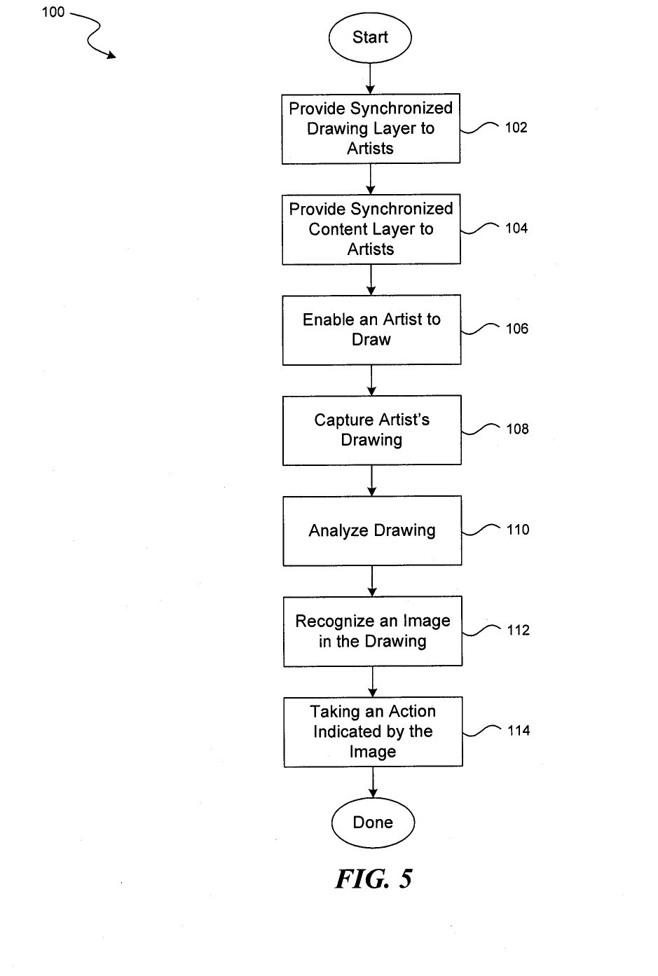

FIG. 5 illustrates a method 100 according to one embodiment for providing an interface to an ensemble event experience including a drawing layer. In certain embodiments, a fundamental design criteria is to provide a computer interface without a keyboard. The method 100 provides such a computer interface.

At 102, the method 100 provides a synchronized drawing layer to a plurality of artists operating a plurality of devices. Synchronization can be indicated by various means, such as synchronizing artists drawing input across all devices such that each artist sees the same image of the drawing layer. At 104, the method 100 provides a synchronized content layer to the plurality of artists and their devices. At 106, the method 100 enables a specific artist acting with one or more devices to draw utilizing the drawing layer. At 108, the method 100 captures the artist's drawing. At 110, the method 100 analyzes the captured drawing. This may be through handwriting recognition algorithms, performed locally and/or distributed. At 112, the method 100 recognizes and/or identifies an image within the drawing layer that has a recognized meaning and/or action to take. For example, an answer to a quiz or an object trace. The drawing layer can be using services in the background, services like character recognition. Example of trivia game, many users get the trivia question displayed on the drawing layer, say it is multiple choice, the users draw in their answer (“1” or “2” or “3”), the drawing gets a time stamp so you know who won the race or such. At step 114, the method 100 proceeds by taking an action indicated by the recognized image and relevant context. The action could be, for example, associate the drawing with a virtual experience and facilitate distribution of the virtual experience.

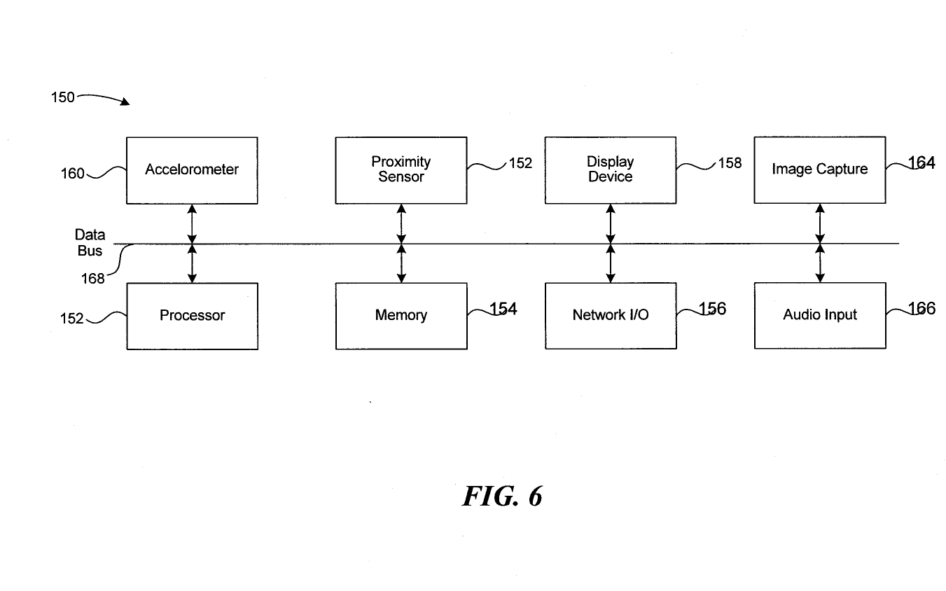

FIG. 6 illustrates a portable device 150 suitable for use by a participant in accordance with one embodiment of the present invention. The portable device 150 architecture and components are merely illustrative. Those skilled in the art will immediately recognize the wide variety of suitable categories of and specific devices such as a cell phone, an iPad, an iPhone, a portable digital assistant (PDA), etc. The portable device 150 includes a processor 152, a memory 154, a network i/o device 156, a display device 158, and a plurality of sensors such as accelerometer 160, a proximity sensor 162, a image capture device 164, and an audio input device 166, all in communication via a data bus 168. The processor 152 could include one or more of a central processing unit (CPU) and a graphics processing unit (GPU). The portable device 150 can work independently to sense user participation in an event, and provide corresponding event feedback. Alternatively, the portable device 150 could be a component of a system which elements work together to facilitate the event.

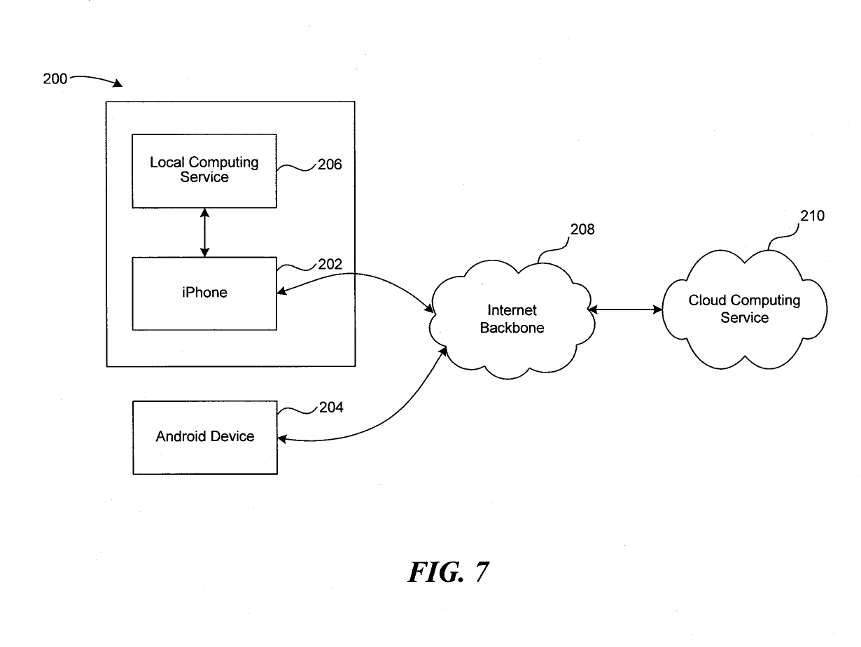

FIG. 7 illustrates a system 200 suitable for facilitating an ensemble event involving a plurality of participants or artists. The system 200 includes a plurality of portable devices such as iPhone 202 and Android device 204, a local computing device 206, and an Internet connection coupling the portable devices to a cloud computing service 210. In this embodiment, gesture recognition functionality is provided at the portable devices in conjunction with cloud computing service 210, as the application requires. In one example, the system 200 could provide a social experience for a variety of participants. As the participants engage in the social experience, the system 200 can ascertain the variety of participant responses and activity. As the situation merits, the system can facilitate participation, and provide the appropriate interface. Each participant can have unique feedback associated with their actions, such as each user having a distinct sound corresponding to their clapping gesture, or a color associated with a drawing tool. In this way, the event has a social aspect indicative of a plurality of participants.

In addition to the above mentioned examples, various other modifications and alterations of the invention may be made without departing from the invention. Accordingly, the above disclosure is not to be considered as limiting and the appended claims are to be interpreted as encompassing the true spirit and the entire scope of the invention.

I claim:

1. A computer implemented method for providing a computer interface without keyboard for a social ensemble experience to a plurality of artists, the method comprising:
providing a drawing layer synchronized across multiple artist devices;
providing a content layer synchronized across the multiple artist devices;
via the drawing layer as instantiated at a specific device for an artist, enabling the artist to draw, and capturing the artist's drawing;
recognizing when the artist has drawn an image having a specific meaning;
determining a present context at the time of recognizing the specific meaning;
taking an action indicated by the specific meaning in light of the present context.

2. A computer implemented method as recited in claim 1, wherein the image is recognized as a trace of an object found in the content layer, the object having an associated virtual experience.

3. A computer implemented method as recited in claim 2, wherein the action includes giving the artist rights in the associated virtual experience.

4. A computer implemented method as recited in claim 1, wherein the image drawn by the artist is intended as an answer to a query related to the content layer.

5. A computer implemented method as recited in claim 4, further including performing character recognition on the image.

6. A computer implemented method as recited in claim 5, further including time stamping the image.

7. A computer implemented method as recited in claim 1, further including geostamping the image.

8. A computer implemented method as recited in claim 7, wherein the image is geostamped for purposes benefiting the artist.

9. A computer implemented method as recited in claim 7, wherein the image is geostamped for analytic purposes.
